(19) United States
(12) Patent Application Publication
(10) Pub. No.: US 2008/0287144 A1
(43) Pub. Date: Nov. 20, 2008

(54) Vehicles as Nodes of Wireless Sensor Networks for Information Collection & Prognostication

(76) Inventors: Ashok Sabata, Freehold, NJ (US); Bikash Sabata, Beverly Hills, CA (US); Reshad Moussa, Lausanne (CH)

Correspondence Address: AGINOVA INC, 3 CHAMBRY COURT, FREEHOLD, NJ, 07728, US

(21) Appl. No.: 11/750,459

(22) Filed: May 18, 2007

(51) Int. Cl. H04M 1/00

(52) U.S. Cl. 455/456.6

(57) ABSTRACT

A system and method are provided that use mobile sensor nodes for monitoring of mobile assets and one or more mobile sensor nodes have mobility that is unpredictable to a wireless network. The mobile sensor nodes collect data with the goal of monitoring the environment including weather and pollution, biological and chemical agents for security application and traffic application. The mobile sensors form local groups opportunistically to coordinate measurements and other actions. The collected sensor data will be stored locally with global positioning system (GPS) data and the time of data collected. The information can be transmitted to a remote computer opportunistically using a low cost method such as WiFi or the cell phone network. The information will be aggregated to provide environmental maps, traffic maps and maps to first responders in the event of biological nuclear or chemical calamity.

### TECHNICAL FIELD OF THE INVENTION

The present invention relates to using vehicles as nodes in a mobile wireless sensor network system for coordinated data collection with the goal of monitoring the environment including weather and pollution, biological and chemical agents for security application and track the vehicle for traffic application. The collected sensor data will be stored locally with global positioning system (GPS) data and the time of data collected. Local collections are aggregated with other collections in a distributed and opportunistic manner to form regional collections. The information can be transmitted to a remote computer opportunistically using a low cost method such as but not restricted to WiFi or the cell phone network. The information will be aggregated to provide environmental maps, traffic maps and maps to first responders in the event of biological or chemical calamity.

### BACKGROUND OF INVENTION

Wireless sensor networks are increasingly being deployed within a physical environment of interest, and may measure aspects of the physical environment in great detail. Sensor networks have numerous applications, such as security, industrial monitoring, military reconnaissance, agricultural monitoring and others. Wireless sensor networks generally comprise of sensor nodes that are each operable to perform some measurement and communicate wirelessly. Sensor nodes are commonly equipped, with sensor(s), local storage, a processor, and wireless transceiver. Such sensor nodes typically have short-range wireless communication capability.

The sensor nodes are often inexpensive and have limited computation, memory, and communication capability and typically consume low power therefore are generally expected to be long-lived, untethered, and unattended for extended periods of time (years); the nodes typically communicate using short-range wireless communication. Sensor nodes may be deployed in a wireless sensor network as an ad-hoc deployment, wherein sensor nodes are dropped with no particular plan or pre-defined arrangement. After being deployed in this ad-hoc manner, the sensor nodes interact with each other to establish a communication network among them. In another deployment technique, sensor nodes are specifically placed in desired locations, wherein the sensors may be precisely positioned relative to one another. In a typical wireless sensor network the nodes are static and collect data periodically and independent of other sensors for aggregation and integration at a centralized back end computing system. The sensor data from wireless sensor network is communicated to an application that is located remote from the wireless sensor network.

In United States there are more than 100 million vehicles on the road. Typically the automobile industry instruments the vehicles with sensors for the purpose of safety of the particular vehicle it instruments and for providing location information using GPS. These vehicles have never been considered as part of a sensor network with the vehicles acting as nodes in the network for monitoring its surroundings.

Vehicles, including trucks and automobiles nowadays are increasingly equipped with myriad of sensors to provide diagnostic data to improve safety, engine performance and provide global positioning system (GPS) data. Koll (which is incorporated herein as reference U.S. Pat. No. 6,895,310) has proposed using sensors and vehicle telemetry data to improve safety and provide better customer service. Sensors measure weather conditions, environmental conditions, traffic conditions, and or road conditions and vehicle telemetry data including global positioning system (GPS) data, vehicle operational data, and engine performance data. Koll does not treat the vehicle as part of a sensor network to provide global information, nor does it consider the inter-vehicle local coordination among vehicle sensors for forming regional information.

Horvitz et al. (which is incorporated herein as reference US Patent Application 20060106530) describe using data from multiple sources to predict traffic patterns. The data can be from anywhere including from sensors associated with roadways such as fixed magnetic, optical, acoustical, or radar-centric sensors installed on or near roadways, visual analysis of scenes captured by video cameras, information gleaned from GPS logging occurring in fleets of vehicles such as might be available from instrumented buses, taxis, delivery vehicles, and the dynamics of signal strengths, such as GSM carrier signals, sensed by cell phones, or sensed at the antennae of cell phone providers, contextual data and suitable data relevant to a traffic-pattern predictive application. Horvitz et al. have focused on a predictive model for traffic patterns and consider the vehicle as one of the source for data collection; they do not consider the vehicle as part of a wireless sensor network, nor do they consider the inter-vehicle local coordination among the vehicle sensors for forming regional information.

### BRIEF SUMMARY OF THE INVENTION

An embodiment of the present invention provides a system and method which use a vehicle as a mobile sensor node for monitoring. One or more of these mobile sensor nodes are independently movable, to communicate their sensor data to another mobile sensor node and vice versa (i.e. the mobile sensor nodes exchange their data with each other) when within range. The mobile sensor nodes that return to or when it has access to a static wireless network all the sensor data (i.e. its own data and the data from all the mobile nodes that it has communicated with when it was away from the wireless network) can then be communicated to the application. The mobile sensor nodes have on board memory to store sensor data and a wireless transceiver to form the network and communicate the data to the remote application.

In accordance with at least one embodiment, a system comprising a plurality of mobile sensor nodes. At least one of the pluralities of nodes comprises a) an interface for communicating via wireless communication with other mobile nodes and b) an interface for communicating via a transient communication link with wireless network. The system further comprises at least one mobile sensor node that comprises an interface for communicating with a node external to the wireless network wherein the interface is operable for communicating a range longer than the mobile sensor node for accessing the wireless network for performing at least one of a) collecting data from the mobile sensor and b) communicating data to the mobile sensor.

Also, according to at least one embodiment a system comprises a vehicle as a mobile sensor node comprising a plurality of means for measuring a characteristic of the environment including weather, pollution, biological and chemical agents and its GPS coordinates and communicating via wireless. The sensors are independently movable and are capable of traveling outside communication range of the wireless network, and wherein there exists at least one mobile sensor that will travel within range of the wireless network to perform the desired data communication with it. If determined that it is in range for transient communication, the wireless network communicates a wake-up signal to the mobile sensor node to cause it to increase its power to a level suitable for communication.

Further, according to at least one embodiment, a method comprises forming an local ad-hoc network among a collection of mobile sensor nodes (referred to as the local group) that are independently movable and are capable of traveling outside communication range of the wireless sensor network, and wherein a statistical probability exists that a group of the accessing means will travel within range of at least one of the local group members other than itself to perform the desired communication with another in addition to exchanging data.

Further, according to at least one embodiment, a method comprises of securing the privacy of the data of one consumer as it travels through the resources of another independent wireless network operator.

Further, according to at least one embodiment, a method comprises of generating environmental maps, predicting traffic patterns and predicting spread of chemical and biological agents in the event of a calamity with data aggregated from at least a reasonable number of mobile sensor nodes to synthesize a global picture using local information. Models using statistics, probablities and various artifical intelligence tools when applied to historic data (i.e. all stored data in a remote computer) generate a global view as well as predict patterns of traffic and spread of pollution or chemical and biological agents in the environment. The models are also learning tools that use their past predictions to improve the accuracy of future predictions.

The aforementioned outline broadly describes the features and technical advantages of the present invention in order that the detailed description of the invention that follows may be better understood. Additional features and advantages of the invention will be described hereinafter which form the subject of the claims of the invention. It should be appreciated that the conception and specific embodiment disclosed may be readily utilized as a basis for modifying or designing other structures for carrying out the same purposes of the present invention.

### BRIEF DESCRIPTION OF THE DRAWINGS

For the present invention to be clearly understood and readily practiced, the present invention will be described in conjunction with the following figures, wherein:

FIG. 1 is a schematic of the components of a mobile sensor node, the static wireless network and the remote computer;

FIG. 2 is a diagram of vehicles as mobile sensor nodes exchanging data when with in range;

FIG. 3 is a diagram of vehicles as mobile sensor node coming with in range of a static wireless network; and

FIG. 4 is an illustration of data transport path from mobile sensor nodes to remote computer.

### DETAILED DESCRIPTION OF THE INVENTION

While the present invention will be described more fully it is to be understood at the outset of the description which follows that persons of skill in the appropriate arts may modify the invention herein described while still achieving the favorable results of this invention. Accordingly, the description which follows is to be understood as being a broad, teaching disclosure directed to persons of skill in the appropriate arts, and not as limiting upon the present invention.

First briefly in overview, the present invention relates to using vehicles as nodes in a mobile wireless sensor network system for data collection with the goal of monitoring the environment including weather and pollution, detection and spread of biological and chemical agents for security application and tracking vehicles for traffic application. The collected sensor data will be stored locally with global positioning system (GPS) data and the time of data collected. The local sensor data may be exchanged and aggregated with other nodes in the local sensor network to form regional information maps. The information can be transmitted to a remote computer opportunistically using a low cost method such as WiFi or the cell phone network. The information will be aggregated to provide environmental maps, traffic maps that predict traffic patterns and maps that provide awareness of the situation to first responders in the event of biological or chemical calamity.

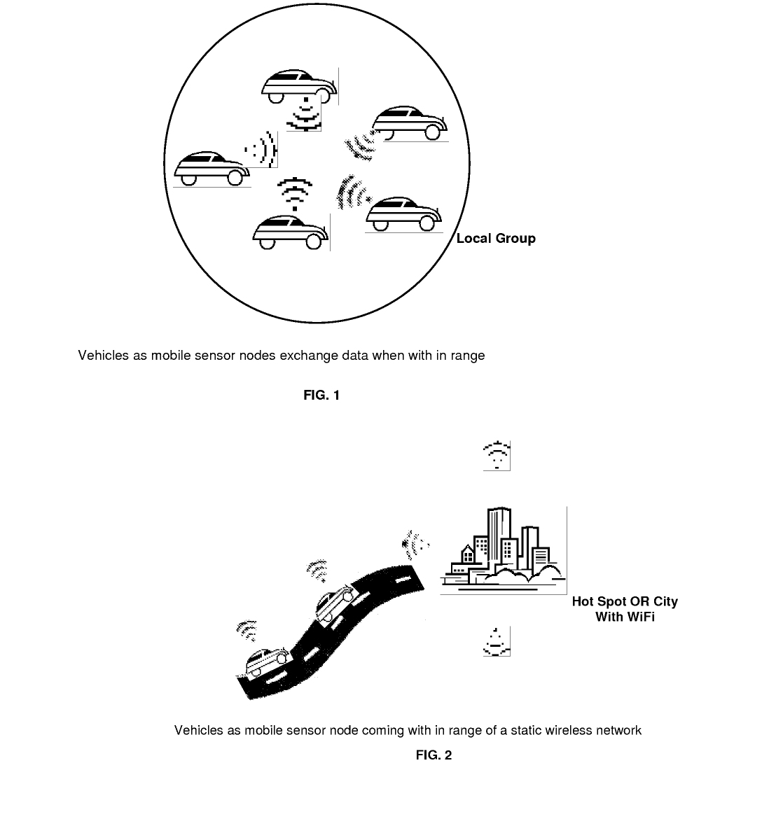

The current invention proposes using a low power mobile wireless sensor network that use motes, which are wireless transceivers with well defined I/O and standard antenna connectors, microcontroller, and integrated with micro sensors. FIG. 1 shows a schematic of the various components of the mobile sensor node. The mobile sensor nodes, using the appropriate radio, communicate over any allowed frequency band. Typically, the mobile sensor nodes use the Industrial, Scientific, and Medical (ISM) band frequencies (902-928 MHz, 2.4-2.4835 GHz, 5.15-5.35 GHz, and 5.725-5.825 GHz) for communication.

With over 100 million vehicles on the rails and road in United States, using vehicles such as automobiles, trucks, buses and trains as sensor nodes will provide a semantically rich data set that can be used for prognostication and generating detailed spatio-temporal maps of the environment. Wireless sensor networks are ideal for remote monitoring as they are a low cost solution that can work with low power (it can operate on battery). A key challenge to using vehicles as sensor nodes is that the extraction of sensor data from the mobile nodes to a remote computer is not easy. One or more of these mobile sensor nodes are independently movable therefore using a traditional wireless sensor network is not possible. Using a direct satellite communication link or a cell phone link is possible and routinely done using systems such as On Star used by General Motors (GM). The cost of such direct communication makes its prohibitive for use across all vehicles and in addition there is no direct communication between the nodes.

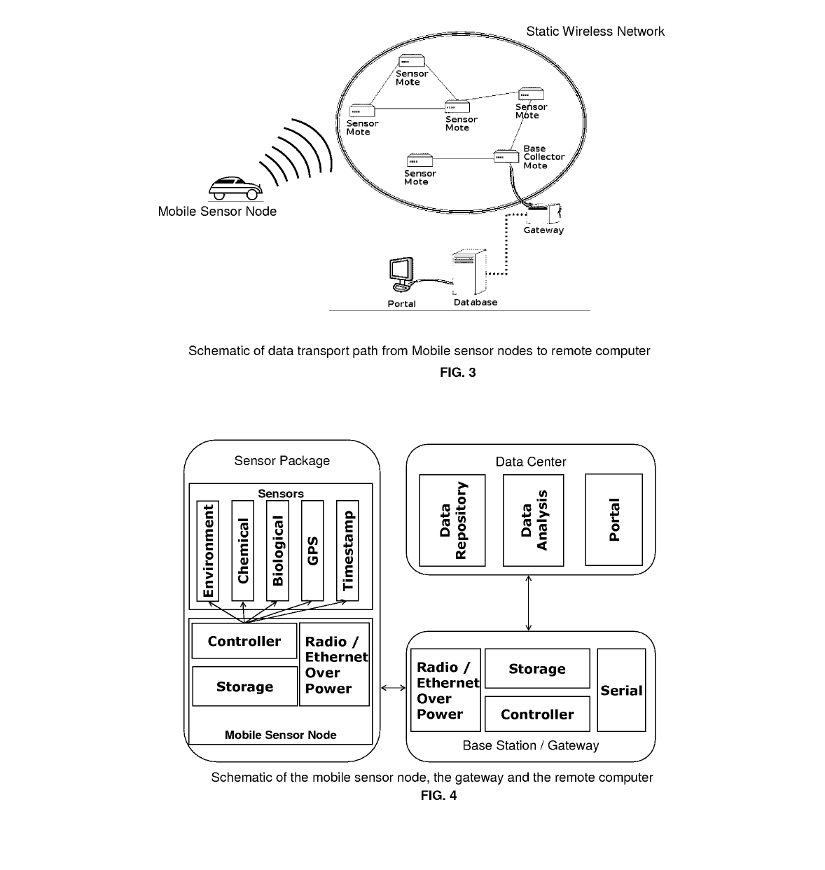

In a particularly preferred embodiment, a mobile sensor node can form an adhoc network, with another mobile node forming a local group, when within range and exchange their data with each other. FIG. 2 is a diagram of mobile sensor nodes exchanging data. As shown in FIG. 3. the mobile sensor nodes that return to or when it has access to a static wireless network all the sensor data (i.e. its own data and the data from all the mobile nodes that it has communicated with when it was away from the wireless network) can then be communicated to the application. An example of mobile sensor node returning to a wireless sensor network includes an automobile users returns homes wherein the wireless network at home communicates to the sensor node (on the vehicle) for transfer of data stored onboard the sensor node.

As shown in FIG. 1 the mobile node comprises a) an interface for communicating via wireless communication with other mobile nodes; b) an interface for communicating via a transient communication link with wireless network; c) a microcontroller to process and aggregate the sensor data; and d) onboard memory to store the sensor data. The system further comprises at least one mobile sensor node that comprises an interface for communicating with a node external to the wireless network wherein the interface is operable for communicating a range longer than the mobile sensor node for accessing the wireless network for performing at least one of a) collecting data from the mobile sensor and b) communicating data to the mobile sensor.

With a low cost viable end-to-end communication solution between the vehicle and the remote computer in place the next challenge is to define the various types of monitoring. Automotive companies have focused on vehicle diagnostics and its impact on safety related functionalities. Using the vehicle as a sensor node in a massive and dynamic sensor network changes the paradigm from monitoring of a particular vehicle to using vehicle as a node for global monitoring that is not directly related to individual vehicle performance and safety. According to at least one embodiment the mobile sensor node comprises a plurality of means for measuring a characteristic of the environment, traffic patterns and hazardous chemical & biological monitoring. Environment monitoring includes weather and pollution. Traffic patterns are determined by recording the GPS co-ordinates with a timestamp that allows the calculation of location and speed of the vehicle. Chemical and biological monitoring can be critical in the event of a calamity where the diffusion of these hazardous elements in the environment can be tracked for alerts to first responders as well as to the general population to determine evacuation routes.

A large sensor network as envisioned in the invention will result in large amounts of data. Analytical tools have been routinely utilized for large datasets. According to at least one embodiment, a method comprises of generating environmental maps, predicting traffic patterns and predicting spread of chemical, nuclear and biological agents in the event of a calamity with data aggregated from at least a reasonable number of mobile sensor nodes to synthesize a global picture using local information. Models using statistics, probabilities and various artificial intelligence tools when applied to historic data (i.e. all stored data in a remote computer) generate a global view as well as predict patterns of traffic and spread of chemical and biological agents in the environment. The models are also learning tools that use their past predictions to improve the accuracy of future predictions.

What is claimed is:

1. A method using a vehicle as a mobile sensor node comprising: at least one mobile sensor node with a wireless communication device is independently movable, to communicate its sensor data directly to a node in a static wireless network or to exchange sensor data with another mobile sensor node when within range with the purpose of aggregating, interpreting, coordinating and communicating the data to a remote application.

2. The method of claim 1 further comprising: deploying a plurality of said mobile sensor nodes, each having mobility that is unpredictable and at least one mobile sensor node determining if it is in range for wireless communication with at least another mobile node or with said node in a static wireless network; and if determined that said at least one mobile sensor node is in range for wireless communication, said node communicates a wake-up signal to said at least one mobile sensor node to cause it to increase its power to level suitable for communication.

3. The method of claim 1 further comprising: distributing sensors, including said at least one mobile sensor, wherein the sensors are operable to capture measurement data for a feature of interest.

4. The method of claim 1 wherein said at least one mobile sensor is operable to perform at least one of the following: capture measurement data for a feature of interest, Timestamp information or spatial location information, sensing, actuation, computation, data storage, and communicating data.

5. The method of claim 1 wherein there is asynchronous coordination among mobile sensor nodes with the static wireless sensor network wherein the mobile nodes synchronize their data and data collection strategies with the static wireless network when they are within communication range of the static wireless network.

6. The method of claim 1 wherein the privacy of the sensor data of one mobile sensor node is secured as it travels through the resources of another mobile node or a static node to the remote application.

7. The method of claim 1 wherein the static wireless network is a wireless hot spot, or a city wide wireless network, or a wireless network at a home or an office.

8. A system comprising plurality of vehicles as mobile sensor nodes wherein at least one of the pluralities of nodes comprises a) an interface for communicating via wireless communication with other mobile sensor nodes to form an ad-hoc wireless sensor network; b) an interface for communicating via a transient communication link with static wireless network; c) a plurality of means for measuring a characteristic of the environment; d) records timestamp and spatial location information; e) plurality of means for aggregating local information and coordinating collection strategies; and e) store and forward information.

9. The system of claim 8 comprises the plurality of means for measuring a characteristic of the environment including weather, pollution, biological and chemical agents in the environment.

10. The system of claim 8 wherein the timestamp information identifies when the data was captured by a mobile sensor node.

11. The system of claim 8 wherein the spatial location information provides a relational spatial position reference of a mobile sensor node that captured the data at the time of its capturing the data.

12. The method of claim 8 wherein the sensor and timestamp information is stored locally and forwarded when within range of another mobile sensor node or a static wireless network.

13. A method comprising of mobile sensor nodes that form an ad-hoc wireless sensor network with other mobile nodes that is local group and said mobile nodes are independently movable and are capable of traveling outside communication range of the ad-hoc wireless sensor network, and wherein a statistical probability exists that a group of the accessing means will travel within range of at least one of the local group members other than itself to perform communication between with another in addition to exchanging data.

14. The method of claim 13 wherein the communication between mobile nodes is for exchanging stored information and for communication between passengers in vehicles that form the local group.

15. A method comprising: aggregating mobiles sensor data and predictive models that generates environment maps, predicts traffic patterns and provides chemical and biological maps for first responders in the event of a calamity.

16. The method of claim 15 wherein environment maps are generated from aggregating and computing and processing of the data from the environmental sensors on the vehicles and its GPS co-ordinates.

17. The method of claim 15 wherein traffic patterns are generated using predictive models that use GPS information of individual mobiles nodes in combination with the timestamp information and environmental sensor data.

18. The method of claim 15 wherein chemical and biological maps are generated by aggregating and computing information from chemical sensors, biological sensors, GPS co-ordinates and timestamp information from the mobiles sensor nodes.
